(19) United States
(12) Patent Application Publication
(10) Pub. No.: US 2015/0213776 A1
(43) Pub. Date: Jul. 30, 2015

(54) COMPUTING SYSTEM AND METHOD FOR AUTOMATICALLY MAKING A DISPLAY CONFIGURATION PERSISTENT

(71) Applicant: Nvidia Corporation, Santa Clara, CA (US)

(72) Inventors: Piyush Sharma, Pune (IN); Praful Jotshi, Pune (IN)

(73) Assignee: Nvidia Corporation, Santa Clara, CA (US)

(21) Appl. No.: 14/163,956

(22) Filed: Jan. 24, 2014

(51) Int. Cl. G09G 5/00; G06F 3/14

(52) U.S. Cl. CPC G09G 5/005; G09G 5/006; G06F 3/1431; G06F 3/1446; G09G 2360/04; G09G 2360/121; G09G 2370/22; G09G 2300/026

(57) ABSTRACT

A computing system and method for automatically making a display configuration persistent. One embodiment of the computing system includes: (1) a video adapter coupled to a data bus and operable to interface a display configuration associated with extended display identification data (EDID), (2) a cache configured to store the EDID, and (3) a central processing unit (CPU) coupled to the data bus and the cache, and operable to execute a driver associated with the video adapter and configured to detect the display configuration and cause the EDID to be written to the cache.

### TECHNICAL FIELD

This application is directed, in general, to display configurations for computing systems and, more specifically, to automatically detecting and making a display configuration persistent.

### BACKGROUND

Many computing systems support numerous display configurations for a variety of applications. The simplest display configuration would be a single display. Most single display configurations are driven by a single video source, while certain others are of high enough resolution to be driven by multiple video sources that are concurrently displayed. Many modern computing systems support a second display useful for cloning and spanning desktop images. Some more advanced computing systems support display configurations having three or more displays arranged in a variety of patterns. For example, one display configuration features four displays arranged in a two-by-two grid pattern, also known as a mosaic display configuration. The mosaic display configuration generally uses a one-by-one grid pattern or larger. Another display configuration features three displays arranged in a left-center-right pattern, also known as a surround display configuration, which is popular for gaming applications. Still other display configurations are possible, with any number of displays.

To enable the numerous display configurations available in modern computing systems, each digital display carries extended display identification data (EDID) that describes that display's capabilities. EDID is typically stored on a read-only memory (ROM) in the display. When the display is connected to a computing system, the EDID is read by the computing system over the video channel and used to configure the video output for that channel. EDID is a standard controlled by the Video Electronics Standards Association (VESA) and includes manufacturing information, pixel mapping data, timing data, display size, and many other parameters.

Most modern computing systems support “hot-plugging” and “hot-unplugging” of displays to some extent. Hot-plugging and hot-unplugging refers to making and breaking the video connection between a display and a video source (i.e., the computing system) while the video source is powered on and generating video output. For example, a display can be hot-unplugged from a personal computer (PC) by disconnecting the video cable from either the display or the PC. The same is true for a variety of video interfaces, including digital visual interface (DVI) and high-definition multimedia interface (HDMI). Another way to hot-plug and hot-unplug is common, but not necessarily exclusive, to laptop PCs configured to interface with a docking station. The docking station generally provides a static desktop configuration for an otherwise mobile PC. A typical docking station includes a mouse, keyboard, and a display that automatically connect to the mobile PC upon “docking.” When the docking station is connected to one or more displays, docking and undocking the mobile PC while powered on effectively hot-plugs and hot-unplugs the one or more displays.

Typically, when a display is hot-unplugged the video source loses the EDID signal and eventually terminates “scan-out” over the channel. Scan-out refers to the process of generating and transmitting rendered frames onto a video channel. When the display is hot-plugged, the video source re-acquires the EDID signal, configures the video output, and begins scan-out. In some cases, hot-plugging a display can require some manual configuration of the video output by a user.

### SUMMARY

One aspect provides a computing system. In one embodiment, the system includes: (1) a video adapter coupled to a data bus and operable to interface a display configuration associated with EDID, (2) a cache configured to store the EDID, and (3) a central processing unit (CPU) coupled to the data bus and the cache, and operable to execute a driver associated with the video adapter and configured to detect the display configuration and cause the EDID to be written to the cache.

Another aspect provides a method of automatically making a display configuration persistent. In one embodiment, the method includes: (1) caching EDID associated with the display configuration, (2) hot-unplugging a display of the display configuration, and (3) employing the EDID to force scan-out of rendered frames.

Yet another aspect provides a computing system. In one embodiment, the system includes: (1) a video adapter coupled to a data bus and operable to interface a display configuration associated with EDID, (2) a cache configured to store the EDID, (3) a memory configured to store an application, and (4) a CPU coupled to the data bus, the cache, and the memory, and operable to: (4a) execute a driver associated with the video adapter, and operable to detect the display configuration and cause the EDID to be written to the cache, and (4b) gain access to the cache and the memory, and employ the EDID to execute the application, thereby causing the video adapter to scan-out rendered frames.

### BRIEF DESCRIPTION

Reference is now made to the following descriptions taken in conjunction with the accompanying drawings, in which:

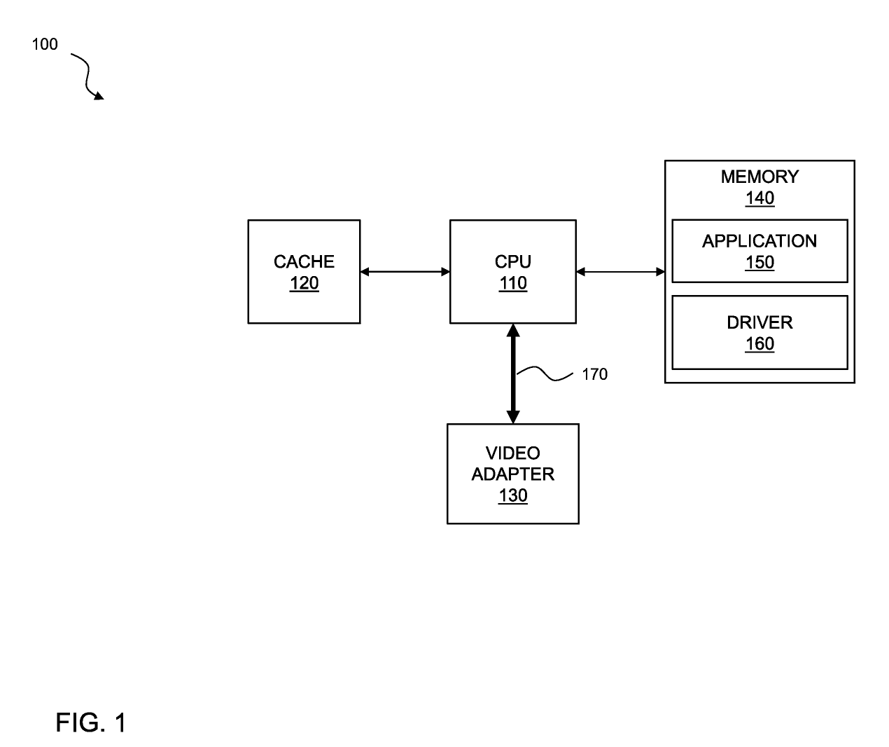

FIG. 1 is a block diagram of one embodiment of a computing system;

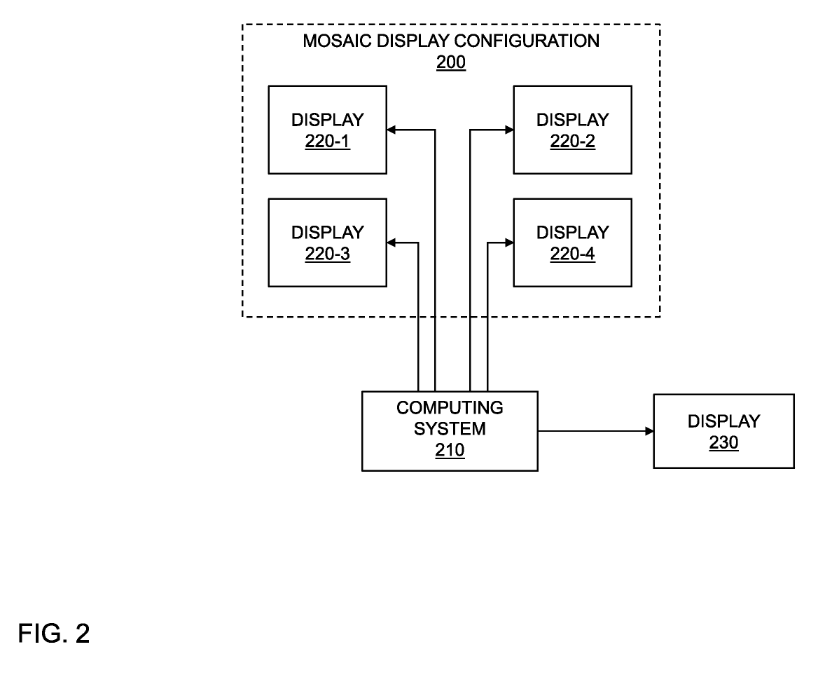

FIG. 2 is a block diagram of one embodiment of a display configuration;

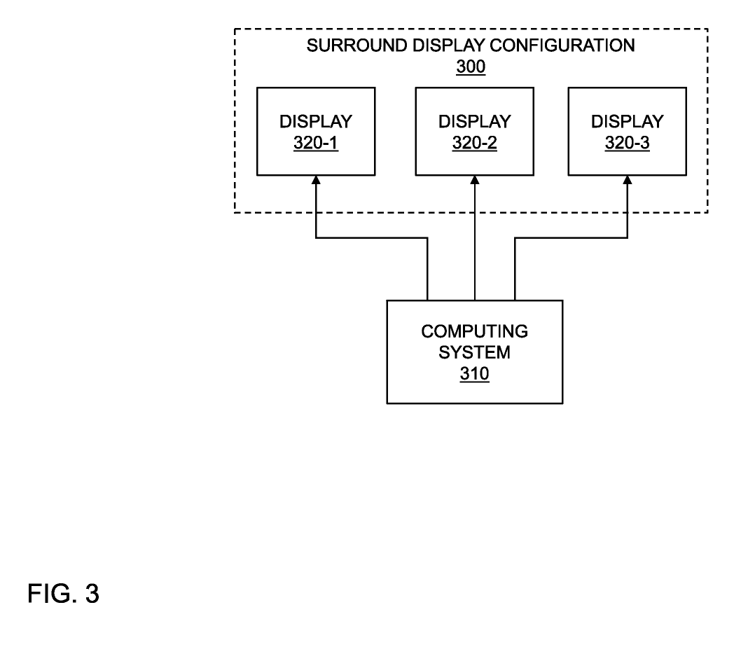

FIG. 3 is a block diagram of another embodiment of a display configuration;

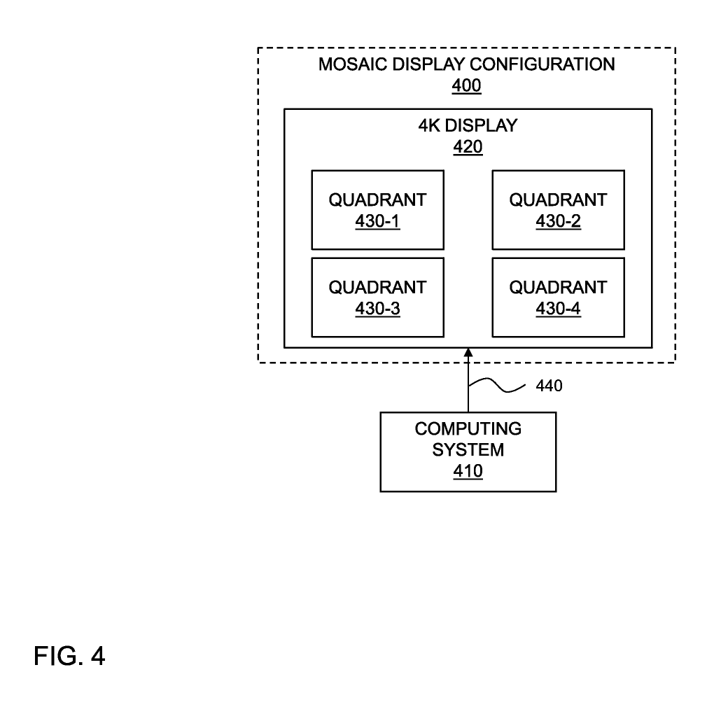

FIG. 4 is a block diagram of yet another embodiment of a display configuration; and

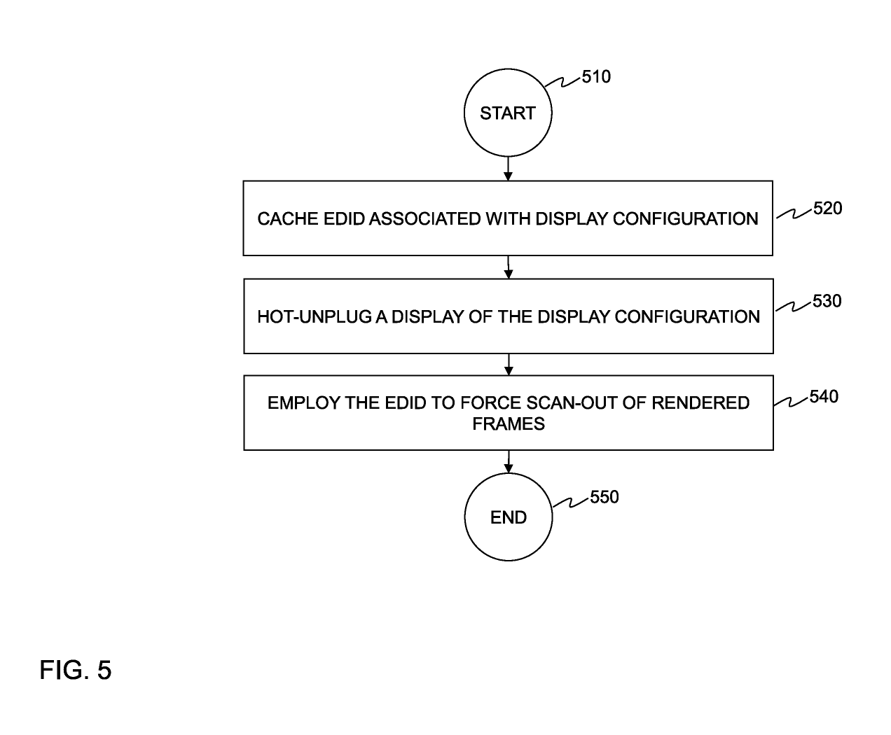

FIG. 5 is a flow diagram of one embodiment of a method of automatically making a display configuration persistent.

### DETAILED DESCRIPTION

Computing systems interface a display configuration through a video adapter. Video adapters come in a variety of configurations. Some are nearly-independent systems that interface the central processing unit (CPU) over a data bus, generally referred to as graphics cards or graphics processing subsystems. Some video adapters are integrated into the motherboard of the computing system. In either case, the video adapter is responsible for interfacing a display configuration by generating rendered frames and transmitting them over a video channel via a video interface, such as DVI, HDMI, VGA, or some other interface, to the display configuration. If the display configuration includes multiple displays or otherwise requires multiple video channels to drive the display configuration, then the video adapter would include multiple video channels and sometimes parallel graphics processing units (GPUs) and dedicated memory.

During the course of interfacing the display configuration, the video adapter receives EDID associated with the display configuration for its host computing system, which is the video source. During normal operation, various software and processes running on the computing system use the EDID to affect their output, most relevantly, their video output. The video adapter serves the EDID to these software and processes through a device driver, or simply “driver.” A driver is a computer program that operates or controls a particular device attached to the computing system. The driver executes on the CPU of the computing system and provides an interface for other software and processes to use the particular device. Other software includes applications and operating systems (OS). The driver associated with the video adapter allows other software and processes to generate video output that can ultimately be displayed. Additionally, the driver associated with the video adapter provides EDID access to the other software and processes. When a display in the display configuration is hot-unplugged and the EDID signal lost, the driver can no longer serve the EDID to the other software and processes. The EDID does not persist through a hot-unplug.

In certain OS, modifications to the display configuration, such as a hot-unplug of one display, result in a loss of EDID and cause the OS to carry out a mode-set to “tear down” the display configuration. The mode-set halts scan-out through the video adapter for the hot-unplugged channel. In certain applications, modifications to the display configuration make it necessary to reload the application or driver to support the new display configuration.

It is realized herein that the driver associated with the video adapter can detect the display configuration and determine if the display configuration calls for the EDID to persist through a hot-unplug. A display configuration calls for the EDID to persist if the display configuration would benefit from “forcing EDID” for that display configuration. It is realized herein that certain display configurations and certain applications may benefit more than others. Mosaic display configurations having multiple displays would benefit more than a system with a single display, because each of the multiple displays can require configuration. Similarly, some applications must be terminated and re-executed upon a hot-unplug, because of the changes in data necessary for removing or changing a display. It is further realized herein that the ability to automatically determine if the EDID should persist can be an option available to users of the computing system.

It is also realized herein that the driver associated with the video adapter can cache EDID for the display configuration such that it persists through a hot-unplug. When other software needs access to the EDID, the driver serves the cached EDID. The other software, such as an OS or other application is unaware of the modification to the display configuration. As a result, the application and OS continue to cause scan-out through the video adapter. Applications that would otherwise require rebooting upon the loss of EDID can continue operating as if no hot-unplug has happened.

FIG. 1 is a block diagram of one embodiment of a computing system 100. Computing system 100 includes a CPU 110, a cache 120, a video adapter 130 coupled to CPU 110 by a data bus 170, and memory 140. Memory 140 is configured to store an application 150 and a driver 160.

CPU 110 is configured to gain access to memory 140 and retrieve application 150 for execution. As CPU 110 executes application 150, CPU 110 generates graphics data and rendering commands that are passed to video adapter 130 over data bus 170. Data bus 170 is a motherboard-level interconnect for linking motherboard-mounted peripherals, such as video adapters. There are a variety of possible embodiments of data bus 170, including: peripheral component interconnect (PCI), PCI Express, PCI Extended (PCI-X), accelerated graphics port (AGP), and others.

Video adapter 130 is responsible for interfacing a display configuration to which computing system 100 is connected. The display configuration can have one or more displays, each having respective EDID. Video adapter 130 receives the graphics data and rendering commands from CPU 110 over data bus 170. Video adapter 130 processes the graphics data by carrying out the received rendering commands on the graphics data. The resulting rendered frames are then transmitted through one or more video interfaces toward the display configuration. Video adapter 130 also uses the video interfaces to receive EDID over the one or more video channels. The received EDID provides information about each display in the display configuration.

CPU 110 also executes driver 160. Driver 160 is a device driver associated with video adapter 130 and provides an interface to operate or control video adapter 130. Application 150 uses driver 160 to communicate with video adapter 130, thereby enabling scan-out of the rendered frames. Driver 160 also uses the EDID to determine if the display configuration can benefit from persistent scan-out and, if it can benefit, stores the EDID in cache 120. The cached EDID for the display configuration persists through any hot-unplugging and hot-plugging action.

Driver 160 uses certain fields of the EDID to identify particular displays in the display configuration. Driver 160 can also use manual display configuration parameters to determine the display topology in use. In certain embodiments, driver 160 uses data from application 150 to determine if the EDID should be cached. For example, medical imaging systems often use particular display topologies and generally benefit from persistence.

Upon execution of application 150, CPU 110 retrieves the EDID from cache 120. Application 150 uses the EDID to configure its video output. For example, application 150 can use the EDID to configure the vertical and horizontal dimensions of generated frames. Application 150 can also use the EDID to configure the frame rate. The EDID includes many other parameters that can be useful to application 150, including: chromaticity data, timing data, synchronization data, and others. When a hot-unplug of a display in the display configuration occurs, the EDID for that display persists in cache 120, and is therefore available to application 150.

When the hot-unplugged display is hot-plugged back to computing system 100, or when another display is hot-plugged in place of the original, scan-out continues as it had while hot-unplugged. The hot-plugged display receives the stream of rendered frames from the channel and begins displaying.

FIG. 2 is a block diagram of one embodiment of a display configuration, mosaic display configuration 200. Mosaic display configuration 200 is driven by a computing system 210. The mosaic topology includes a grid arrangement of displays, displays 220-1 through 220-4. Each of displays 220-1 through 220-4 is connected to a respective video channel having computing system 210 as the video source. Additionally, computing system 210 is connected to a display 230 that is outside mosaic display configuration 200. Display 230 is useful as a primary display while mosaic display configuration 200 is used for a special purpose, such as a presentation. For example, computing system 210 can be a laptop PC configured to drive mosaic display configuration 200.

Alternate embodiments of mosaic display configuration 200 can include any number of displays. The minimum grid size is one-by-one, or a single display. The dimensions of the mosaic grid can grow from there to meet the demands of each unique application. Some embodiments may include a four-by-four topography, while others a two-by-eight. The combinations are bounded only by the usefulness of a particular topography.

A hot-unplug for mosaic display configuration 200 includes disconnecting one or more of the respective video channels for the associated displays within mosaic display configuration 200. Upon hot-unplug, the remaining connected displays continue as if nothing has changed, while the one or more hot-unplugged video channels continues scan-out, but its displays are blank or not illuminated. Upon a hot-plug of the hot-unplugged display or another similar display, mosaic display configuration 200 continues displaying as if the hot-unplug and hot-plug had never occurred.

FIG. 3 is a block diagram of another embodiment of a display configuration, surround display configuration 300. The surround topology includes three displays, left display 320-1, center display 320-2, and right display 320-3. Surround display configuration 300 is connected to a computing system 310, which serves as the video source. The surround topology is popular in gaming applications. Hot-unplugging for surround display configuration 300 includes disconnecting one or more of the left, center, and right video channels. Upon hot-unplug, the remaining connected channels continue as if nothing has changed. The hot-unplugged channel continues scan-out, but its associated display is blank or not illuminated. Upon hot-plugging of the hot-unplugged display or a similar display, surround display configuration 300 continues displaying as if the hot-unplug and hot-plug had never occurred.

FIG. 4 is a block diagram of yet another embodiment of a display configuration, mosaic display configuration 400. Mosaic display configuration 400 includes a 4K display 420. “4K” refers to the approximate horizontal resolution of the display, which is typically 3840 pixels by 2160 lines (3840×2160). 4K display 420 has the display capacity of four high-definition (HD) displays, which have a resolution of 1920×1080. 4K display 420 is connected to a computing system 410 by a video interface 440. In certain embodiments, video interface 440 is a single video channel capable of carrying the full “4K” frames. A hot-unplug in those embodiments would include disconnecting video interface 440, at which point all of 4K display 420 would be blank or not illuminated. When video interface 440 is hot-plugged, 4K display 420 would be illuminated again as if it had never been hot-unplugged. In alternate embodiments, video interface 440 includes multiple video channels that are combined and displayed by 4K display 420. For example, certain embodiments of 4K display 420 can be connected to computing system 410 by four video channels, each carrying one-quarter of the video content to be displayed. A hot-unplug in these embodiments would include disconnecting one or more of the multiple video channels, at which point the one or more quadrants associated with the one or more disconnected video channels would be blank or not illuminated.

In the embodiment of FIG. 4, mosaic display configuration 400 is configured to display 4K content in quadrants 430-1 through 430-4. Video interface 440 is operable to deliver the content to 4K display 420 for display in a two-by-two grid arrangement. Each of quadrants 430-1 through 430-4 is configured to display frames rendered independently with respect to each other and displayed concurrently. In alternate embodiments, the quadrants are rendered together as a single frame spanning all four quadrants.

FIG. 5 is a flow diagram of one embodiment of a method of automatically making a display configuration persistent. The method begins in a start step 500. In a caching step 520, EDID associated with the display configuration is cached in a memory. Caching is carried out by a driver associated with a video adapter and executing on the video source, typically a computing system having a CPU for processing and hosting the video adapter. In certain embodiments, the computing system and CPU also execute an application that uses the cached EDID to configure its video output.

In alternate embodiments, the method also includes an auto-detection step. In auto-detection, the driver determines whether the connected display configuration would benefit from automatically making the display configuration persistent. If the display configuration would benefit, caching step 520 is carried out. In certain other embodiments, the computing system also executes an application, such as an OS, that provides a user option to enable or disable the auto-persist feature.

In the embodiment of FIG. 5, once the EDID is cached in caching step 520, a display in the display configuration is hot-unplugged at hot-unplugging step 530. Upon hot-unplugging, the cached EDID persists. Then, in a scan-out step 540, the cached EDID is employed to force scan-out of rendered frames, effectively ignoring the effects of hot-unplugging step 530. In certain embodiments, the cached EDID is employed in an application that uses the EDID to configure its video output. In other embodiments, the cached EDID is employed by an OS running on the computing system. The OS continues using the EDID and thereby causes scan-out to continue as if the hot-unplugging had never occurred.

In some embodiments, in a hot-plugging step, the hot-unplugged display or a similar display is reconnected, allowing the previously hot-unplugged video channel to resume displaying as if no changes had occurred. Given the persistent EDID in the cache, no reconfiguration of the display configuration or applications using the EDID is necessary. The method then ends in an end step 550.

Those skilled in the art to which this application relates will appreciate that other and further additions, deletions, substitutions and modifications may be made to the described embodiments.

What is claimed is:

1. A computing system, comprising:
a video adapter coupled to a data bus and operable to interface a display configuration associated with extended display identification data (EDID);
a cache configured to store said EDID; and
a central processing unit (CPU) coupled to said data bus and said cache, and operable to execute a driver associated with said video adapter and configured to detect said display configuration and cause said EDID to be written to said cache.

2. The computing system as recited in claim 1 wherein said cache is persistent with respect to modifications to said display configuration.

3. The computing system as recited in claim 2 wherein said modifications include hot-plugging and hot-unplugging a display in said display configuration.

4. The computing system as recited in claim 1 wherein said display configuration includes a mosaic configuration.

5. The computing system as recited in claim 1 wherein said CPU is further operable to execute an application, thereby generating graphics data on which a rendered frame displayed on said display configuration is based.

6. The computing system as recited in claim 5 wherein said driver is further configured to detect execution of said application and employ the detection to detect said display configuration.

7. The computing system as recited in claim 5 wherein said CPU is further configured to gain access to said cache and employ said EDID to force scan-out of said rendered frame through said video adapter based on said display configuration.

8. A method of automatically making a display configuration persistent, comprising:
caching extended display identification data (EDID) associated with said display configuration;
hot-unplugging a display of said display configuration; and
employing said EDID to force scan-out of rendered frames.

9. The method as recited in claim 8 further comprising auto-detecting if said display configuration calls for said caching.

10. The method as recited in claim 9 further comprising enabling said auto-detecting.

11. The method as recited in claim 9 wherein said auto-detecting includes detecting execution of an application that calls for auto-persist.

12. The method as recited in claim 8 further comprising employing said EDID in executing an application on which said rendered frames are based.

13. The method as recited in claim 8 wherein said caching persists through said hot-unplugging.

14. The method as recited in claim 8 further comprising hot-plugging a display.

15. A computing system, comprising:
a video adapter coupled to a data bus and operable to interface a display configuration associated with extended display identification data (EDID);
a cache configured to store said EDID;
a memory configured to store an application and a driver associated with said video adapter; and
a central processing unit (CPU) coupled to said data bus, said cache, and said memory, and operable to:
execute said driver, wherein said driver is operable to detect said display configuration and cause said EDID to be written to said cache, and
gain access to said cache and said memory, and employ said EDID to execute said application, thereby causing said video adapter to scan-out rendered frames.

16. The computing system as recited in claim 15 wherein said display configuration includes a plurality of displays having respective EDID.

17. The computing system as recited in claim 15 wherein said display configuration includes a single display operable to concurrently display a plurality of independently rendered frames.

18. The computing system as recited in claim 15 wherein said EDID stored in said cache are configured to persist through a hot-unplug of a display in said display configuration.

19. The computing system as recited in claim 18 wherein said driver is further operable to employ said EDID stored in said cache to cause said application and said video adapter to continue scan-out upon said hot-unplug.

20. The computing system as recited in claim 15 wherein said driver is configured to recognize a plurality of display configurations and applications for which said EDID are cached, thereby automatically making said display configuration persistent.
